(19) United States
(12) Patent Application Publication
(10) Pub. No.: US 2024/0263920 A1
(43) Pub. Date: Aug. 8, 2024

(54) TARGET ACQUISITION SYSTEM FOR AN UNMANNED AIR VEHICLE

(71) Applicant: CODE PLANET SAVER OY, Imatra (FI)

(72) Inventor: Arto KOIVUHARJU, Imatra (FI)

(21) Appl. No.: 18/561,057

(22) PCT Filed: May 18, 2022
(86) PCT No.: PCT/FI2022/050335

§ 371 Date: Nov. 15, 2023

(30) Foreign Application Priority Data
May 18, 2021 (FI) 20215590

(51) Int. Cl. F41G 3/16; G05D 1/224; G05D 105/35; G05D 109/25; G06F 3/01; G06T 11/00; G06V 20/17; G06V 20/20; H04N 7/18

(52) U.S. Cl. CPC F41G 3/165; G05D 1/2249; G06T 11/00; G06V 20/17; G06V 20/20; H04N 7/183; G05D 2105/35; G05D 2109/254; G06F 3/012; G06T 2200/24

(57) ABSTRACT

The application relates to a target acquisition system (100) for an unmanned aircraft (106) according to an embodiment. The system comprises goggles (110) and the unmanned aircraft. The unmanned aircraft equipped with a camera (124) and a measuring unit (230) is configured to transmit location data (DS, KA, DE) related to a location (MS) of a target (102) to the goggles. The goggles are configured to form an augmented reality user interface (LK) by means of at least one goggle lens (212) for controlling the unmanned aircraft. The goggles equipped with an orientation detector (213) are configured to present to a wearer (108) of the goggles the location of the target as an augmented reality target object (MB) in the user interface based on the received target location data and an orientation (SA) of the goggles as detected by the orientation detector.

### TECHNICAL FIELD

The application relates in general to a target acquisition system for an unmanned aircraft.

### BACKGROUND

In modern warfare, unmanned aerial vehicles, or drones, are used for reconnaissance by transmitting video from the drone camera to a tablet computer that acts as a portable terminal for the drone pilot. The pilot can view the video image from the drone camera on the computer touchscreen and observe the target almost unnoticeably without risking his or her own life.

Drones can also be equipped with explosives, allowing armed drones remotely controlled via a tablet computer to be used in targeted strikes to destroy a target. After detecting a target from video transmitted by the drone, the pilot indicates the target on the video displayed on the touchscreen by touching it, and controls, by touching an attack command displayed on the computer user interface, the drone to dive towards the indicated target and destroy it by colliding into it and, at the same time, detonating the explosive device it is carrying.

The use of an armed, unmanned drone in targeted strikes is a viable alternative to indirect fire strikes because of the deployment and control of the drone by a single pilot, the ability to launch the drone from anywhere it can get up from the launch pad, and the accuracy of the drone's guidance.

### SUMMARY

One objective of the invention is to solve problems in the known art and to provide a target acquisition system that enables safe target identification, surveillance, targeting of an armed unmanned aircraft or direct fire weapon at a designated target, and destruction of the designated target by control through user eye or hand movement and thought in an augmented reality user interface without endangering the life of the user of the target acquisition system. The target acquisition system allows the pilot to make and implement decisions quickly, giving the pilot more time to observe the target and its surroundings.

One objective of the invention is achieved by a target acquisition system, goggles, an unmanned aircraft, target acquisition methods, a computer program, and a computer program product according to the independent claims.

Embodiments of the invention comprise a target acquisition system, goggles, an unmanned aircraft, target acquisition methods, a computer program, and a computer program product according to the independent claims.

According to an embodiment of the invention, a target acquisition system for an unmanned aircraft comprises goggles and an unmanned aircraft. An unmanned aircraft equipped with a camera and a measuring unit is configured to transmit location data related to a location of a target to the goggles. The goggles are configured to form (provide) an augmented reality user interface by means of at least one goggle lens for controlling of the unmanned aircraft. The goggles equipped with an orientation detector are configured to present to a wearer of the goggles the location of the target as an augmented reality target object in the user interface based on the received target location data and an orientation of the goggles as detected by the orientation detector.

According to a second embodiment of the invention, goggles for acquiring a target for an unmanned aircraft comprise a data transceiver configured to receive location data related to a location of a target transmitted by the unmanned aircraft equipped with a camera and a measuring unit. A processor of the goggles is configured to form (provide) an augmented reality user interface by means of at least one goggle lens for controlling of the unmanned aircraft. The user interface of the goggles is configured to present to a wearer of the goggles, by means of an orientation detector, the location of the target as an augmented reality target object in the user interface based on the received target location data and an orientation of the goggles as detected by the orientation detector.

According to a third embodiment of the invention, a target acquisition method on an unmanned aircraft comprises a step of receiving, a data transceiver, location data related to a location of a target transmitted by the unmanned aircraft equipped with a camera and a measuring unit. The method further comprises a step of forming (providing), by a processor, an augmented reality user interface using at least one goggle lens for controlling the unmanned aircraft. The method further comprises a step of presenting, by (using) the user interface, to a wearer of the goggles, by means of an orientation detector, the location of the target as an augmented reality target object in the user interface based on the received target location data and an orientation of the goggles as detected by the orientation detector.

According to a fourth embodiment of the invention, an unmanned aircraft for acquiring a target comprises a camera configured to provide video (a video image) comprising the target. A processor of the aircraft is configured to identify the target from the video provided. A measuring unit of the aircraft is configured to obtain an orientation of the camera and a distance of the camera to the identified target. A positioning unit of the aircraft is configured to obtain a location of the unmanned aircraft to determine location data related to a location of the target based on obtained information on the camera orientation, the distance between the camera and the target, and the location of the unmanned aircraft. A data transceiver of the aircraft is configured to transmit the location data to the goggles used to control the unmanned aircraft in order to present the target as an augmented reality target object in an augmented reality user interface by means of at least one goggle lens in the goggles.

According to a fifth embodiment of the invention, a target acquisition method on (using) an unmanned aircraft comprises a step of providing video showing a target by a camera of the unmanned aircraft. The method further comprises a step of identifying, by a processor of the unmanned aircraft, the target from the video provided. The method further comprises a step of obtaining, by a measuring unit of the unmanned aircraft, an orientation of the camera and a distance of the camera to the identified target. The method further comprises a step of obtaining, by a positioning unit of the unmanned aircraft, a location of the unmanned aircraft to determine location data related to a location of the target based on obtained information on the camera orientation, the distance between the camera and the target, and the location of the unmanned aircraft. The method further comprises a step of transmitting, by a data transceiver of the unmanned aircraft, the location data to the goggles used to control the unmanned aircraft in order to present the target as an augmented reality target object in an augmented reality user interface by means of at least one goggle lens in the goggles.

According to a sixth embodiment of the invention, a computer program for target acquisition for an unmanned aircraft comprises instructions which, when executed on a computer, cause the computer to carry out the steps of the target acquisition method according to the previous third of fifth embodiment.

According to a seventh embodiment of the invention, a computer program product for target acquisition for an unmanned aircraft stores the computer program according to the previous sixth embodiment.

Further embodiments of the invention are indicated in the dependent claims.

### BRIEF DESCRIPTION OF THE FIGURES

In the detailed description of the figures, exemplary embodiments of the invention are described in more detail with reference to the following figures:

FIG. 1a shows the positioning of the location of a target in a target acquisition system for display in the goggles user interface

FIG. 1b shows target acquisition in the target acquisition system by means of goggles

FIGS. 2a-2b show the functional components of the goggles and the unmanned aircraft

### DETAILED EXPLANATION OF THE FIGURES

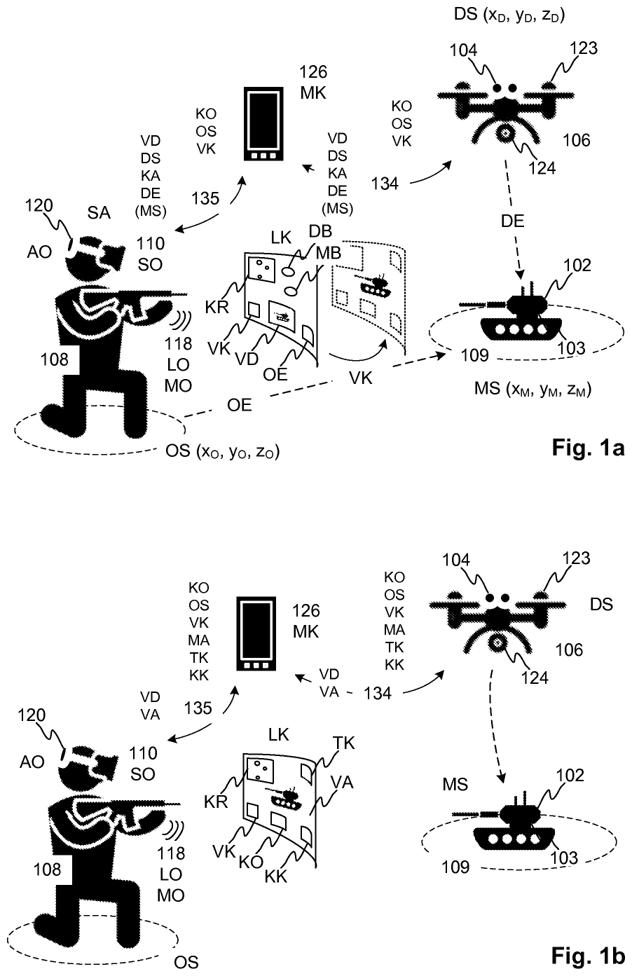

FIGS. 1a and 1b depict a target acquisition system 100 for identifying and positioning a target 102 by at least one armed and unmanned aircraft (UA, drone, unmanned aerial vehicle) 106 and for indicating the target 102 to at least one armed and unmanned drone 106.

The system 100 includes a drone 106 used to identify (detect), locate, point and destroy a target 102 without the operator (wearer, user, pilot, target acquirer) 108 of the drone 106 being in direct visual contact with the target 102, whereby the pilot 108 is also not exposed to possible direct fire from the target 102 or its surroundings 109.

The drone 106 is an aircraft without a human pilot and is of a type such as a radio-controlled aircraft (aeroplane), multicopter 106 (as depicted in the figures), airship, tethered balloon or similar type of aircraft.

The drone 106 is armed with at least one weapon 104, which comprises one, two, three, four or more weapons 104 as shown. The weapon 104 may be an explosive 104, as shown, intended to detonate upon impact of the drone 106 on a designated target 102, or, in contrast to what is shown, a missile, rocket or an automatic firearm that fires bullets or grenades on a designated target 102.

The drone 106 includes a motion generator 270 for generating the force required to move (fly) the drone 106 in the air and directing the motion generated by the force in accordance with predetermined commands or commands KO from the pilot 108. The motion generator 270 comprises a motor 271 and at least one rotor 123 or propeller driven by it, e.g., one, two, three, four or more rotors 123 or propellers.

The drone 106 has a camera 124 for producing video VD, VA for controlling the drone 106 and for locating and indicating a target 102 and destroying it with a weapon 104. The video VD, VA transmitted by the drone 106 enables the pilot 108 to observe the surroundings of the drone 106 and to identify and locate the target 102 from the video VD, VA at a distance without being physically detected. Video VD, VA is video in digital format (video image data) VD or video in analogue format VA. The drone 106 is intended to transmit digital video VD until it receives a switch command VK, at which point it starts transmitting analogue video VA. Alternatively, the drone 106 is intended to transmit only digital video VD or analogue video VA. Alternatively, the drone 106 is intended to transmit analogue video VA until it receives a switch command VK, at which point it starts transmitting digital video VD.

The camera 124 is equipped with a multi-axis, such as two- or three-axis, stabilizer (gimbal) 227 for stabilizing the camera 124 to produce a steady video image VD, VA while the drone 106 and the camera 124 are in motion. The stabilizer 227 is equipped with an automatic target 102 tracking system, which allows the pilot 108 to use the camera 124 to track the moving target 102 and pan the surroundings 109.

In the system 100, the drone 106 observes the surroundings 109 with the camera 124 and tries to identify the target 102 from the digital video VD with the help of a self-learning recognition system based on pattern and/or image recognition.

The drone 106 further comprises a positioning unit (positioner) 228 for tracking the location DS (x_{S}, y_{S}, z_{S}) of the drone 106 and determining its location (location data) DS, i.e., positioning the drone 106. The positioning unit 228 uses satellite positioning, such as the Global Positioning System (GPS), the Glonass, Galileo or Beidou systems, or Global System for Mobile Communications (GSM) based positioning.

The drone 106 further comprises a measuring unit (measurer) 230 for determining the distance DE between the drone 106 (camera 124) and the target 102 identified with the help of the video VD transmitted by the camera 124. The measuring unit 230 comprises an optical rangefinder, such as a laser rangefinder, or an ultrasonic rangefinder.

The measuring unit 230 is further intended to observe the orientation (direction) KA of the camera 124 and to determine its orientation (orientation data) KA in three-dimensional (3D) space as it obtains the distance DE. Therefore, the measuring unit 230 further comprises an inertial measurement unit (IMU) comprising at least one orientation sensor, such as one, two, three, four or more sensors, for orientation sensing. Sensors used include at least one accelerometer, a gyroscope and possibly a magnetometer.

In the system 100, the location (location data) MS (x_{M}, y_{M}, z_{M}) of the target 102 can be determined on the basis of the distance DE and orientation KA obtained by the measuring unit 230 and the location DS obtained by the positioning unit 228.

The system 100 further includes goggles 110 for the pilot 108 to protect the eyes of the pilot 108 to maintain vision and to provide, by means of at least one translucent goggle lens 212, a user interface LK based on augmented reality (AR) to be used in the steering of the drone 106, enabling the pilot 108 to receive from the drone 106 at least the information KR, MB, DB, OE displayed in the video VD, VA required by the pilot 108, and to control the operation of the drone 106 and the camera 124 via a wireless two-way radio link 134, 135. The at least one goggle lens 212 comprises one, two, three, four or more goggle lenses 212.

The user interface LK is intended to present to the pilot 108 at least the video VD, VA received by the goggles 110 from the drone 106, commands (command objects, elements, icons) KO, VK, TK, KK used to control the drone 106 and its camera 124, generated in the user interface LK, a target object MB indicating the location MS and distance OE of the target 102 and a drone object DB indicating the location of the drone 106 in the goggle view, a map KR showing the locations MS, DS, OS of respectively the target 102 visible in the video VD, VA, the drone 106 and the pilot 108, if not presented elsewhere in the system 100, and other data related to the control of the drone 106 or its camera 124, such as data related to the drone's flight, weather and drone characteristics. The user interface LK is further intended to receive an eye control SO performed by the pilot 108 with his or her eyes, a motion control LO performed with a gesture of a hand 118, and a thought control AO performed with a thought.

The goggles 110 include an orientation detector 213 intended to observe the orientation SA of the goggles 110 in 3D space and to determine (obtain) the orientation (orientation data) SA of the goggles 110. The orientation detector 213 further comprises an inertial measurement unit comprising at least one orientation sensor, such as one, two, three, four or more sensors, for orientation sensing. Sensors used include at least one accelerometer, a gyroscope and possibly a magnetometer.

The goggles 110 further include an eye tracker 214, which allows the pilot 108, by shifting his or her gaze, to provide an eye control SO to issue a target acquisition MA or other command KO in the user interface LK. The eye tracker 214 observes the eye movements of the pilot 108 and uses them to identify the spot in the user interface LK indicated by the user's eye control SO. The eye tracker 214 comprises at least one digital camera or optical sensor, e.g. one, two, three, four or more cameras or sensors.

The goggles 110 further comprise a motion tracker 216, which enables the pilot 108, by moving at least one hand 118, to give a target acquisition MA or other command KO in the user interface LK by means of a motion control LO. The motion tracker 216 observes the movements of the pilot's 108 hand 118 and uses them to identify a spot on the user interface LK indicated by the pilot 108 with motion control LO. The motion tracker 216 comprises at least one digital camera or optical sensor, e.g. one, two, three, four or more cameras or sensors.

The goggles 110 further comprise a thought sensor (brain sensor) 120, which enables the pilot 108 to issue a command KO, TK, KK as a thought control AO in the user interface LK by thinking of a command KO, TK, KK. The thought sensor 120 observes the electrical activity in the brain of the pilot 108 and, based on this, identifies the command KO, TK, KK issued by the pilot 108 with the thought control AO in the user interface LK. The thought sensor 120 comprises at least one sensor that detects brain electrical activity, e.g. one, two, three, four or more sensors.

The goggles 110 further comprise a positioning unit (positioner) 217 intended to observe the location OS (x_{O}, y_{O}, z_{O}) of the goggles 110 and, at the same time, of the pilot 108, and to determine the location (location data) OS of the goggles 110 and the pilot 108, i.e. to position itself and the pilot 108 at the same time. The positioning unit 217 uses satellite positioning, such as the GPS, Glonass, Galileo or Beidou systems, or GSM-based positioning.

The goggles 110 further include a controller 211 for, in addition to providing the user interface LK, calculating (determining), with the help of the orientation SA of the goggles 110, the location of an augmented reality target object MB indicating the location MS of the target 102, and the location of an augmented reality drone object DB indicating the location DS of the drone 106 on a user interface LK view provided by at least one goggle lens 112 of the goggles 110. The target object MB and the drone object DB allow the pilot 108 wearing the goggles 110 to see the locations (position, direction) MS, DS of the target 102 and the drone 106 with the goggles 110 even though the pilot 108 may not have a direct line of sight to the target 102 or the drone 106.

Once the goggles 110 have received the distance DE, orientation KA and location DS from the unmanned aircraft 106, the controller 211 calculates the location MS of the target 102 on the basis of these values. Alternatively, the goggles 110 receive the location MS already calculated in the unmanned aircraft 106.

Once the locations MS, OS of the target 102 and the goggles 110 are known to the controller 211, it is able to calculate, based on these values and the orientation SA of the goggles 110, the locations MS, OS of the target object MB and the drone object DB in the augmented reality view visible through at least one goggle lens 112, and to display, based on the locations MS, OS, the distance OE of the goggles 110 and the pilot 108 wearing them from the target 102.

In the system 100, the controller 211 updates the view of the goggles 110 for the pilot 108 if the goggles 110 receive at least one change in the data DE, KA, DS, MS from the unmanned aircraft or detect a change in their own orientation SA.

The goggles 110 further comprise a finger-operated control stick 222, which enables the pilot 108, by moving or pressing the control stick 222 with the finger of the hand 118, to directly issue a control command KO to the drone 106 or its camera 124 as a stick control TO.

The system 100 may further include a mobile terminal 126 carried by the pilot 108, such as a touchscreen tablet computer or smartphone, intended to enhance the communications and data processing capabilities and resources of the system 100, thereby reducing the communications and processing burden of the goggles 120, receive video VD, VA transmitted by the drone 106 via a radio link 134 and transmit it to the goggles 110 via a radio link 135, and receive the target acquisition MO and commands KO from the goggles 110 via a radio link 135, and transmit them to the drone 106 or camera 124 to control it via a radio link 134.

The mobile terminal 126 is further intended to present (provide) a mobile user interface MK for controlling the drone 106 and its camera 124, which allows the mobile terminal 126 to present information to the pilot 108 to facilitate controlling the drone 106 and related decision making, and which allows the pilot 108 to directly issue a command KO to the drone 106 or the camera 124 as a mobile control MO by the movement or pressure of the hand 118. In the user interface MK, it is possible to display e.g. a map KR showing the location MS of a target 102 visible in the video VD, VA, the location DS of the drone 106 and the location OS of the pilot 108, if the map KR is not displayed in the user interface LK.

In addition, in the user interface MK, as in the user interface LK, it is possible to display video VD, VA transmitted by the drone 106, commands KO, VK, TK, KK used to control the drone 106 and its camera 124, generated in the user interface MK, a target object MB indicating the location MS and distance OE of the target 102 and a drone object DB indicating the location of the drone 106 in a view transmitted by the camera of the mobile terminal 126, a map KR showing the locations MS, DS, OS of the target 102 visible in the video VD, VA, the drone 106 and the pilot 108, even if it were presented elsewhere in the system 100, and other data related to the control of the drone 106 or its camera 124, such as data related to the drone's flight, weather and drone characteristics.

In the system 100, prior to acquiring the target 102, the pilot 108 manually controls the drone 106 using the video image VD digitally transmitted by its camera 124 in an attempt to observe the surroundings 109 and the target 102 from the air.

Physical manual control is provided as stick control TO by the control stick 222 of the goggles 110, as motion control LO by the hands 118 of the pilot 108 at the user interface LK or as mobile control MO by the hands 118 at the user interface MK, if the system 100 includes a mobile terminal 126.

Alternatively, the drone 106 can be controlled autonomously (automatically) so that the drone 106 moves based on predetermined guidance without continuous steering from the pilot 108. In this case, the drone 106 is pre-guided to move at a certain flight altitude, at a certain distance from the pilot 108 and in a certain direction (angle) with respect to the pilot 108, such as straight in the direction of the pilot 108 or at some predetermined angle in the horizontal plane with respect to the direction of travel of the pilot 108.

The movement of the autonomous drone 106 is controlled by said predetermined guidance and the pilot's location OS received by it from the goggles 110 via a two-way radio link 134, 135, whereby as the location OS of the pilot 108 changes, the drone 106 moves in the same manner maintaining its predetermined flight altitude, distance and position (angle) relative to the weapon to the pilot 108. The autonomous drone 106 control allows the pilot 108 to focus on, for example, sensory perception of the environment and handling, deploying and, if necessary, using his or her personal weapon, instead of piloting the drone 106.

Regardless of whether the drone 106 is guided manually or in a predetermined manner, the pilot 108 is able to physically control the camera 124 through the control stick 222, the user interface LK or, if the system 100 includes a mobile terminal 126, the user interface MK, via a radio link 134, 135 in order to monitor the surroundings 109.

After the pilot 108 wearing the goggles 110 has sent the drone 106 into flight, it starts transmitting to the goggles 110, directly or through a mobile terminal 126, as shown, via a wireless two-way radio link 134, 135, at least its own location DS determined by the positioning unit 228 and digital video VD captured by the camera 124, and performing identification of the target 102 in the surroundings 109 from the video VD.

While the pilot 108 is observing through at least one goggle lens 112 of the goggles 110 his or her immediate surroundings, or while focusing on some other task, the user interface LK of the goggles 110 displays, as augmented reality elements, a map KR showing, in a two- or three-dimensional map view, the location DS of the drone 106 and the location DS of the pilot 108 as determined by the positioning unit 217 in the goggles 110, and video VD of the surroundings 109 captured by the camera 124. In addition, the view of the user interface LK shows the switch and abort command objects VK, KK and possibly the range information object OE representing the distance of the pilot 108 to a potential target 102. The range information object OE may be hidden or empty until the drone 106 has identified a possible target 102.

The drone 106 observing its surroundings 109 moves autonomously, e.g., taking into account the location OS of the pilot 108, and the pilot 108 is able to take it under manual control when he or she wants to observe in more detail, using video VD from the camera 124, some detail in the surroundings 109 that requires closer examination during the mission.

Once the drone 106 has identified a potential target 102 from the video VD of the surroundings 109 using the identification system, it determines the current distance DE of the camera 124 to the potential target 102 using the measuring unit 230 and the orientation KA of the camera 124, which indicates the direction of the potential target 102 at a distance DE from the current location DS of the drone 106 determined by the positioning unit 228.

After determining the distance DE and orientation KA, the drone 106 sends the data DE, KA together with its location DS directly or through a mobile terminal 126 to the goggles via a radio link 134, 135 or, alternatively, the drone 106 itself calculates the location of the potential target 102 on the basis of the data DS, DE, KA and sends it directly or through the mobile terminal 126 to the goggles 110 via the radio link 134, 135.

The goggles 110 worn by the pilot 108 receive the data DS, DE, KA transmitted by the drone 106 and calculate the location MS of the potential target 102, or, if the drone 106 calculates the location MS, the goggles 110 receive only the location MS.

Once the location MS of the potential target 102 is known (obtained), the goggles 110, using at least one goggle lens 112, present to the pilot 108, in the user interface LK, in addition to the location DS of the drone 106 and the location OS of the pilot 108 determined by the positioning unit 217, the location MS, and determine, by the controller 211, the distance OE of the pilot 108 to the potential target 102 based on the locations OS, MS. After calculating the distance OE, the goggles 110 present it, in the form of a range information object OE, to the pilot 108 in a view of the user interface LK by means of at least one goggle lens 112.

To illustrate the existence of the potential target 102 and the drone 106 to the pilot 108, in addition to the distance OE, the goggles 110 determine their own orientation SA by means of the orientation detector 213 and calculate, by means of the controller 211, the locations of the augmented reality target object MB and drone object DB indicating the location MS of the potential target 102 and the location DS of the drone 106 in the user interface LK view provided to the pilot 108 by at least one goggle lens 112. Then, the controller 211, using at least one goggle lens 112, shows the current calculated locations of the target object MB and drone object DB in the user interface LK displayed by the at least one goggle lens 112. With the help of the target object MB and the drone object DB, the pilot 108 can perceive, when looking through the goggles 110, the direction and distance OE of the potential target 102 and the direction and altitude of the drone 106, even if he or she does not have a direct line of sight to either or both.

When the locations MS, DS of the potential target 102 and the drone 106 are presented as target and drone objects MB, DB in the view of the goggles 110, the pilot 108 can identify the target 102 from the video VD displayed in the user interface LK. The pilot 108 may also guide the drone 106 directly or through a mobile terminal 126 via a radio link 134, 135 closer to the target 102 to facilitate identification. If the target 102 is not considered by the pilot 108 to be an object to be destroyed or damaged, the pilot 108 guides the drone 106 to continue monitoring the surroundings 109 with the camera 124.

If, on the other hand, the pilot 108 reliably identifies the target 102 in the surroundings 109 from the video VD presented by the user interface LK and, after guiding the drone 106, if necessary, to a position more favourable for destroying or damaging the target 102, the pilot 108 physically issues a switch command VK with the control stick 222, in the form of motion control LO in the user interface LK or, if the system 100 includes a mobile terminal 126, in the form of mobile control MO in the user interface MK, in order to switch the drone 106 to transmit and the goggles 110 to receive, instead of digital video VD, analogue video VA, which has a shorter time lag in the user interface VK than digital video VD. The same switch command VK in the system 100 switches the control of the drone 106 from the current predetermined or physical, manual control to pilot's 108 eye control SO to simplify the pointing of the target 102 from the video VA.

After the system 100 switches to eye control SO, the pilot 108 performs target acquisition MA by focusing his or her gaze on the target 102 in the video VA in the user interface LK and, at the same time, on the spot 103 of the target 102 where the pilot 108 wants the drone 106 to strike if it is armed with an explosive 104. The eye tracker 214 detects where the pilot 108 directs his or her gaze in the video VA of the user interface LK, and the user interface LK determines, based on the point (data) received from the eye tracker 214, the spot 103 in the target 102 in the video VA that the pilot 108 points to the drone 106. Alternatively, if the weapon 104 is a missile, rocket or an automatic firearm, the target acquisition MA serves as the aiming point for the weapon 104 to be fired.

After the target acquisition MA by the pilot 108, it is transmitted to the drone 106 via a radio link 134, 135, whereby the drone 106, upon receiving the target acquisition MA, becomes aware of the acquired target 102 and the point of impact (aiming point) 103.

After the target acquisition MA, the system 100 enters a thought control AO mode to destroy the target 102 or damage its functional capability. One of the commands KO presented by the user interface LK is the destruction command TK, which is used by the pilot 108 to instruct the drone 106 to strike the target 102. When the pilot 108 looks at and thinks about the visual destruction command TK presented in the user interface LK, the thought sensor 120 detects from the brain electrical activity that the instructor 108 is thinking about the destruction command TK.

After the destruction command TK is issued by the pilot 108, it is transmitted to the drone 106 via the radio link 134, 135, whereby the drone 106, immediately after receiving the destruction command TK, starts to move towards the target 102 and the impact point 103 defined by the target acquisition MA in order to destroy or damage the target 102. Alternatively, if the weapon 104 is a missile, rocket or an automatic firearm, the drone 106 launches the missile or rocket 104 it is carrying or fires the automatic firearm 104 at the target 102 and aiming point 103 indicated by the target acquisition MA.

After the destruction command TK, as the drone 106 flies towards the designated target 102, the target 102 may, for example, move, in which case there may be a need to adjust the aim of the drone 106. Before the drone 106 strikes the impact point 103, the pilot 108 still has the possibility to control the flight of the drone 106 with eye control SO by giving a new target acquisition MA through the eye tracker 214 by fixing his or her gaze on a target in the video VA in the user interface LK as described above.

One of the commands KO presented by the user interface LK is the abort command KK, which allows the pilot 108 to instruct the drone 106 to abort the mission launched by the destruction command TK. If, after issuing the destruction command TK, the pilot 108 for some reason wishes to abort the destruction of the target 102 before the drone 106 strikes it or the weapon 104 fires, the pilot 108 looks at the visual abort command KK presented in the user interface LK and thinks about it so that the thought sensor 120 detects, based on brain wave activity, that the pilot 108 is thinking about the abort command KK.

After the pilot 108 issues the abort command KK, it is sent to the drone 106 via the radio link 134, 135, whereby the drone 106, immediately after receiving the abort command KK, aborts its dive towards the target 102 and returns to the dive start position DS to await a new target acquisition MA, destruction command TK or flight control KO to move the drone 106 to a new position or away from the area of the target 102.

Alternatively, the pilot 108 may perform the target acquisition MA, instead of the eye control described above, using motion control LO of the hand 118 via the user interface LK, in which case, after a switch command VK issued via the control stick 222 as described above or via the user interface LK, MK, the digital video VD is changed to analogue video VA and the system 100 switches to motion control LO via the user interface LK, if the drone 106 control is implemented autonomously or manual control is implemented with stick control or mobile control TO, MO.

While the system 100 is under motion control LO, the pilot 108 performs target acquisition MA by pointing with his or her hand 118 the target 102 in the video VA in the user interface LK and, at the same time, the exact spot 103 on the target 102 where the pilot 108 wants the drone 106 to strike. The motion tracker 216 detects where the pilot 108 points his or her hand 118 (finger) in the video VA of the user interface LK, and the user interface LK determines, based on the spot received from the motion tracker 216, the spot 103 on the target 102 in the video VA that the pilot 108 points for the drone 106.

After the pilot 108 performs the target acquisition MA, it is sent to the drone 106 in the same way as described above and the system switches to thought control AO to destroy or damage the target 102 as described above. The issuing of the destruction command TK, the operation of the drone 106 after receiving it and the possible issuing of the abort command KK are also performed in the same way as described above for eye control SO.

Also in motion control LO, after issuing the destruction command TK, the pilot 108 still has the possibility to issue a new target acquisition MA with motion control LO by means of the motion tracker 216 by pointing with the hand 118 in the video VA in the user interface LK as described above.

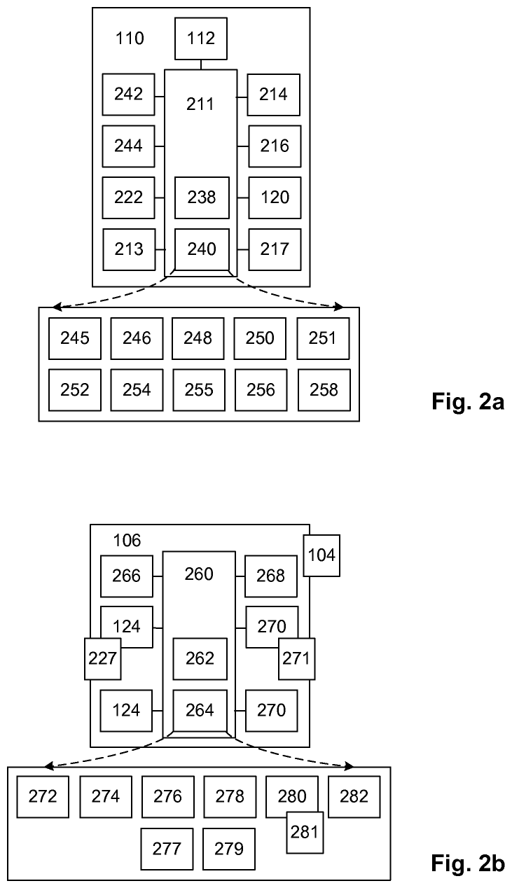

FIG. 2a shows a schematic diagram of the goggles 110 used in the system 100 for indicating a target 102 for an armed drone 106, as shown in the previous figure.

The goggles 110 include a controller 211 by means of which the goggles 110 control their own operation, i.e. the operation of their components 112, 120, 213, 214, 216, 217, 222, 242, 244, so that the goggles 110 operate as described in connection with the previous figure.

The controller 211 includes a processor 238 for executing control commands specified by application programs, such as the application 258, and possibly by the pilot 108 wearing the goggles 110, and for processing data. The processor 238 comprises at least one processor, e.g. one, two, three, four or more processors.

The controller 211 further includes a memory 240 for storing application programs, such as 258, that control the operation of the goggles 110 and are used by it, as well as operational data. The memory 240 comprises at least one memory, e.g. one, two, three, four or more memories.

The goggles 110 further include at least one goggle lens 212, as shown above, for protecting the eyes of the pilot 108 and for providing, by means of the at least one translucent goggle lens 212, a user interface LK for controlling the drone 106.

The goggles 110 further include a power supply 242, by means of which the goggles 110 draw their operating power. The power supply 242 is connected to the controller 211, which controls its operation. The power supply 242 includes a coupler that allows the goggles 110 to be connected to external power sources to charge its power supply 242. The power supply 242 comprises at least one battery, e.g. one, two, three, four or more batteries.

The goggles 110 further include a data transceiver 244, by means of which the goggles 110 transmit commands KO, VK, MA, TK, KK and data OS, OE, VA, VD to at least its other parts 112, 120, 213, 214, 216, 217, 222, 240, 242 and to the drone 106, and receive data transmitted by them and by the drone 106, such as video VD, VA. The data transceiver (transferer) 244 is connected to the controller 211, which controls its operation. Outgoing data transfer from the goggles 110 and incoming data transfer to the terminal 110 takes place using wireless connections. Communication with, for example, the drone 106 takes place directly via a radio link 134 or through a mobile terminal 126 via radio links 134, 135. Data transfer within the goggles 110 takes place through wired connections.

The goggles 110 further include a control stick 222, as described above, which allows the pilot 108, by the movement or pressure of a finger of the hand 118, to directly issue, as stick control TO, the flight control, imaging and switch commands KO, VK to the drone 106 and its camera 124. The control stick 222 is connected to the controller 211, which controls its operation. The control stick 222 comprises at least one physical control stick, e.g. one, two, three, four or more control sticks.

The goggles 110 further include an orientation detector 213, an eye tracker 214, a motion tracker 216, a positioning unit 217 and a thought sensor 120, as described in connection with the previous figure, by means of which the goggles 110 detect their orientation SA, their location OS, the controls SO, LO, AO issued by the pilot 108, and participate, together with the user interface LK, in determining the control commands KO, VK, MA, TK, KK issued on the basis of these.

The memory 240 includes a goggle lens application 245 controlling the operation of at least one goggle lens 212, a power supply application 246 controlling the operation of a power supply 242, a data transfer application 248 controlling the operation of a data transceiver 244, a controller application 250 controlling the operation of a control stick 222, a detector application 251 controlling the operation of an orientation detector 213, an eye tracker application 252 controlling the operation of an eye tracker 214, a motion tracker application 254 controlling the operation of a motion tracker 216, a positioning application 255 controlling the operation of a positioning unit 217, a sensing application 256 controlling the operation of a thought sensor 120, and an augmented reality user interface application (computer software) 258 for the acquisition and destruction of a target 102.

The application 258 includes computer program code (instructions) to control the operation of the goggles 110 as described in connection with the previous figure, when the application 258 is executed jointly by the processor 238 and memory 240 of the control component 211 in the goggles 110.

The application 258 is stored in memory 240 or may be formed into a computer program product by storing it on a computer readable storage medium, which can be read by the goggles 110, for instance.

FIG. 2b shows a schematic diagram of an armed drone 106 used in the system 100 for the safe, easy and quick detection and destruction of a target 102, as described in connection with the previous figures.

The drone 106 includes a controller 260 that allows the drone 106 to control its operation, that is, the operation of its components 104, 124, 227, 228, 230, 266, 268, 270, 271 such that the drone 106 operates as described in connection with the previous figures.

The controller 260 includes a processor 262 for executing control commands specified by application programs, such as the application 282, and possibly by the pilot 108 of the drone 106, and for processing data. The processor component 262 comprises at least one processor, e.g. one, two, three, four or more processors.

The controller 260 further includes a memory 264 for storing application programs, such as 282, that control the operation of the drone 106 and are used by it, as well as operational data. The memory 264 comprises at least one memory, e.g. one, two, three, four or more memories.

The drone 106 further includes a power supply 266, by means of which it draws its operating power. The power supply 266 is connected to the controller 260, which controls its operation. The power supply 266 includes a coupler that allows the drone 106 to be connected to external power sources to charge its power supply 266. The power supply 266 comprises at least one battery, e.g. one, two, three, four or more batteries.

The drone 106 further comprises a data transceiver (transferer) 268, by means of which the drone 106 sends control commands, video VD, VA and data to its other components 104, 124, 227, 228, 230, 266, 270, 271 and to the goggles 110, and receives control commands KO, VK, MA, TK, KK and data OS from them and from the goggles 110. The data transceiver 268 is connected to the controller 260, which controls its operation. Data transfer out of the drone 106 and into the drone 106 takes place using wireless connections. Communication with, for example, the goggles 110 takes place directly via a radio link 134 or through a mobile terminal 126 via radio links 134, 135. Data transfer within the drone 106 takes place through wired connections.

The drone 106 further comprises, as described in connection with the previous figure, a motion generator 270 for generating the force necessary for the drone 106 to move and orient itself, a camera 124 for producing video VD, VA for use by the pilot 108, a positioning unit 228 for determining the location DS of the drone 106, a measuring unit 230 for determining the distance DE of the drone 106 from the target 102 and the orientation KA of the camera 124, and a weapon 104 for destroying or damaging the target 102.

The memory 264 contains a power supply application 272 controlling the operation of a power supply 266, a data transfer application 274 controlling the operation of a data transceiver 268, a flight application 276 controlling the operation of a motion generator 270, a camera application 278 controlling the operation of a camera 124, a stabilizer application 280 controlling the operation of a stabilizer 227, a positioning application 277 controlling the operation of a positioning unit 228, a measurement application 279 controlling the operation of a measuring unit 230, a weapon application 281 controlling the operation of a weapon 104, and a drone application (computer program) 282 for target 102 acquisition and destruction.

The application 282 includes computer program code (instructions) for controlling the drone 106 to operate as described in connection with the previous figures when the application 282 is executed jointly by the processor component 262 and the memory 264 in the control component 260 in the drone 106.

The application 282 is stored in memory 264 or may be formed into a computer program product by storing it on a computer readable storage medium, which can be read by the drone 106, for instance.

The mobile terminal 126 used to control the drone 106, as described in connection with the previous figures, comprises a controller with a processor and memory, a data transceiver and a user interface MK, by means of which (through which) the pilot 108 provides the drone 106, in particular its controller 260, with control commands KO, VK, MA, TK, KK and the data OS it requires, and receives from the drone 106 video VD, VA and the data described above via a radio link 134, 135.

Only some exemplary embodiments of the invention have been described above. Naturally, the principle according to the invention can be modified within the scope of protection defined by the claims, e.g. with regard to implementation details and fields of application.

1. A target acquisition system for an unmanned aircraft comprising:
goggles,
the unmanned aircraft,
which unmanned aircraft, equipped with a camera and a measuring unit, is configured to transmit location data (DS, KA, DE) related to a location (MS) of a target to the goggles,
which goggles are configured to form an augmented reality user interface (LK) by means of at least one goggle lens for controlling the unmanned aircraft, and
which goggles, equipped with an orientation detector, are configured to present to a wearer of the goggles the location of the target as an augmented reality target object (MB) in the user interface based on the received target location data and an orientation (SA) of the goggles as detected by the orientation detector.

2. The target acquisition system according to claim 1, wherein the unmanned aircraft is further configured to identify the target from digital video (VD) captured by the camera and to obtain, by the measuring unit, the location data related to the location of the target after identifying the target.

3. The target acquisition system according to claim 2, wherein the measuring unit is configured to obtain an orientation (KA) of the camera and a distance (DE) of the camera to the target after target acquisition.

4. The target acquisition system according to claim 3, wherein the unmanned aircraft is configured to obtain its location (DS) and transmit it together with the camera orientation and distance (KA, DE) as the location data (DS, KA, DE) to the goggles that are configured to determine the location of the identified target based on the location data and to generate the determined location to be presented as the target object in the user interface.

5. The target acquisition system according to claim 3, wherein the unmanned aircraft is configured to obtain its location (DS), determine the location of the identified target based on its location and camera orientation and distance (KA, DE), and transmit the location of the target as the location data (DS, KA, DE) to the goggles that are configured to generate the determined location to be presented as the target object in the user interface based on the location data received.

6. The target acquisition system according claim 1, wherein the unmanned aircraft is configured to transmit location data related to a change of a location of the target in response to a change in target location and/or the orientation detector is configured to detect a change in the orientation of the goggles in response to a change in the orientation of the goggles, wherein the goggles are configured to re-create the location of the target to be presented as the target object in the user interface based on at least one change that has occurred.

7. The target acquisition system according claim 1, wherein the unmanned aircraft is further configured to transmit video (VD, VA) captured by it to the goggles and the user interface in the goggles is configured to display the received video (VD, VA).

8. The target acquisition system according to claim 1, wherein the goggles are configured to transmit to the unmanned aircraft a location (OS) of the wearer of the goggles and the unmanned aircraft is configured to move autonomously based on predetermined flight control and the received location of the wearer.

9. The target acquisition system according to claim 1, wherein the goggles are configured to determine a distance (OE) of the wearer of the goggles from the target based on a location of the wearer of the goggles and the location of the target, and to present the determined distance of the wearer from the target in the user interface.

10. The target acquisition system according to claim 1, wherein the goggles or a mobile terminal comprised in the goggles are configured to receive a switch command (VK) for the control of the unmanned aircraft issued by the user using physical control in order to switch the control of the unmanned aircraft from autonomous control to eye control (SO) or motion control (LO), and to send the switch command to the unmanned aircraft.

11. The target acquisition system according to claim 10, wherein, after receiving the switch command, the unmanned aircraft is configured to transmit analogue video (VA) to the goggles that are configured to display the received analogue video in the user interface.

12. The target acquisition system according to claim 1, wherein a mobile terminal is configured to relay at least one of the following communications between the goggles and the unmanned aircraft: a location of the wearer transmitted by the goggles, the location data transmitted by the unmanned aircraft, video transmitted by the unmanned aircraft, and a switch command (VK) indicating changes of the transmission format of the video transmitted by the goggles and control mode.

13. Goggles for acquiring a target for an unmanned aircraft, comprising
a data transceiver configured to receive location data (DS, KA, DE) related to a location (MS) of the target transmitted by an unmanned aircraft equipped with a camera and a measuring unit,
a processor configured to form an augmented reality user interface (LK) by means of at least one goggle lens for controlling the unmanned aircraft, and
the user interface configured to present to a wearer of the goggles, by means of an orientation detector, the location of the target as an augmented reality target object (MB) in the user interface based on the received target location data and an orientation (SA) of the goggles as detected by the orientation detector.

14. A target acquisition method on an unmanned aircraft comprising:
receiving, by a data transceiver, location data (DS, KA, DE) relating to a location (MS) of a target transmitted by the unmanned aircraft equipped with a camera and a measuring unit,
forming, by a processor, an augmented reality user interface (LK) using at least one goggle lens for controlling the unmanned aircraft, and
presenting, by the user interface, to a wearer of the goggles, by means of an orientation detector, the location of the target as an augmented reality target object (MB) in the user interface based on the received target location data and an orientation (SA) of the goggles as detected by the orientation detector.

15. An unmanned aircraft for acquiring a target comprising:
a camera configured to provide video (VD, VA) comprising the target,
a processor configured to identify the target from the video (VD) provided,
a measuring unit configured to obtain an orientation (KA) of the camera and a distance (DE) of the camera to the identified target,
a positioning unit configured to obtain a location (DS) of the unmanned aircraft to determine location data (DS, KA, DE) related to a location (MS) of the target based on obtained information on the camera orientation, the distance between the camera and the target, and the location of the unmanned aircraft, and
a data transceiver configured to transmit the location data to the goggles used to control the unmanned aircraft in order to present the target as an augmented reality target object (MB) in an augmented reality user interface (LK) by means of at least one goggle lens in the goggles.

16. A target acquisition method on an unmanned aircraft comprising:
providing video (VD, VA) showing a target by a camera of the unmanned aircraft,
identifying, by a processor of the unmanned aircraft, the target from the video (VD) provided,
obtaining, by a measuring unit of the unmanned aircraft, an orientation (KA) of the camera and a distance (DE) of the camera to the identified target,
obtaining, by a positioning unit of the unmanned aircraft, a location (DS) of the unmanned aircraft to determine location data (DS, KA, DE) related to a location (MS) of the target based on obtained information on the camera orientation, the distance between the camera and the target, and the location of the unmanned aircraft, and
transmitting, by a data transceiver of the unmanned aircraft, the location data determined to the goggles used to control the unmanned aircraft in order to present the target as an augmented reality target object (MB) in an augmented reality user interface (LK) by means of at least one goggle lens in the goggles.

17. A computer program comprising instructions for causing a computer to carry out the method according to claim 14 when the computer program is executed on the computer.

18. A computer program product comprising the computer program according to claim 17 stored on it.
